(19) United States
(12) Patent Application Publication
(10) Pub. No.: US 2007/0119877 A1
(43) Pub. Date: May 31, 2007

(54) Aerosol spray can attachment

(76) Inventor: Donald A. Weltzin, Beaverton, OR (US)

Correspondence Address: James D. Givnan, Jr., 8175 S.W. Ernst Road, Portland, OR, 97225, US

(21) Appl. No.: 11/285,987

(22) Filed: Nov. 25, 2005

(51) Int. Cl. G01F 11/28; B67D 5/06

(52) U.S. Cl. 222/451; 222/452; 222/536

(57) ABSTRACT

A base is detachably mounted on an aerosol canister and includes projections on which an array of spray tubes may be carried for subsequent installation on the combination valve and nozzle of the canister. The base additionally carries a holder for a spray shield and a spray restrictor in a detachable manner. One version of the base seats in place on the uppermost rim of a canister and is provided with a series of projections for spray tubes. A modified base of the attachment includes an insert at its upper end for engagement with cap structure of an aerosol canister with the base lower end in biased engagement with the canister. Base mounted projections additionally carry an assortment of spray tubes.

### BACKGROUND OF THE INVENTION

Discharge from aerosol spray canisters frequently results in overspray, a problem somewhat solved by the use of spray tubes acting on the discharge flow. Discharge of a high viscosity medium accentuates the problem.

In the prior art, U.S. Pat. No. 6,679,438 discloses a spray guard to confine spray ejected from the spray wand of a garden sprayer to prevent undesired contact of the spray with certain plants.

U.S. Pat. No. 3,936,000 discloses a shield for attachment to an aerosol container with a nozzle valve being actuated by lengthwise movement of a conical shield in endwise contact with an area to be sprayed.

U.S. Pat. No. 5,344,076 discloses an aerosol container fitted with a conical shroud with a vent being provided to exhaust excess spray from the aerosol container. A support for the spray shield is adjustable to fit aerosol cans of different diameter.

U.S. Pat. No. 5,360,165 shows a shield or guard is vented to return any spillage and vapors back to the hand held spray gun. Rollers on the end of a shroud are for wall contact to reduce overspray.

U.S. Pat. No. 5,794,855 shows the shield or protector to restrict the spray pattern to a desired area being treated. The shield is intended for attachment to the spray head on a wand of a sprayer and serves to restrict overspray.

U.S. Pat. No. 6,637,151 discloses a guard or shield assembly for confining a spray to a small area, as for example, individual plants in a garden. The spray guard is lengthwise collapsible.

U.S. Pat. No. 4,767,056 discloses a spray guard for use with spray guns where the guard has a conical passageway formed internally in which a pressurized air flow is delivered to the outer end of the spray guard with one of the objectives being to eliminate overspray.

U.S. Pat. No. 3,963,180 discloses a shield for an airless sprayer to protect the user from the penetration of a sprayed medium into the user's skin.

U.S. Pat. No. 3,550,857 shows a shield on an aerosol container attached by a circular cover of the shield snapping into an annular groove at the container upper end.

### SUMMARY OF THE PRESENT INVENTION

The present invention is directed toward providing a canister attachment with a backup supply of spray tubes. A shield protrudes beyond the discharge end of the spray tube to restrict overspray. Provision is made for storing a selection of spray tubes on a base of the attachment. The shield is interchangeable with others of greater or lesser lengths to best suit the task at hand. Backup spray tubes, which may be of different lengths and inside diameters, are carried in a manner avoiding interference with grasping of the aerosol container. The base of the present device, in addition to storing one or more spray tubes flexes for attachment to an aerosol container.

### BRIEF DESCRIPTION OF THE DRAWINGS

In the accompanying drawings:

FIG. 1 is a perspective view of the present attachment in place on an aerosol canister,

FIG. 2 is an exploded view of the present attachment separated from an aerosol canister;

FIG. 3 is a plan view of the attachment and aerosol container with fragments of the attachment broken away for purposes of illustration;

FIG. 4 is a fragmentary side elevational view of the attachment in place on an aerosol canister;

FIG. 5 is a sectional view of a fragment of a shield of the present attachment supporting a conical restrictor;

FIG. 6 is a front elevational view of the attachment on a canister in the hand of a user;

FIG. 7 is a side elevational view of a modified form of the present attachment with fragments broken away for purposes of illustration;

FIG. 8 is a sectional view taken downwardly along line 8-8 of FIG. 7;

FIG. 9 is an enlarged sectional view taken along line 9-9 of FIG. 8;

FIG. 10 is a plan view of the attachment skirt removed from engagement with a cap of an aerosol container.

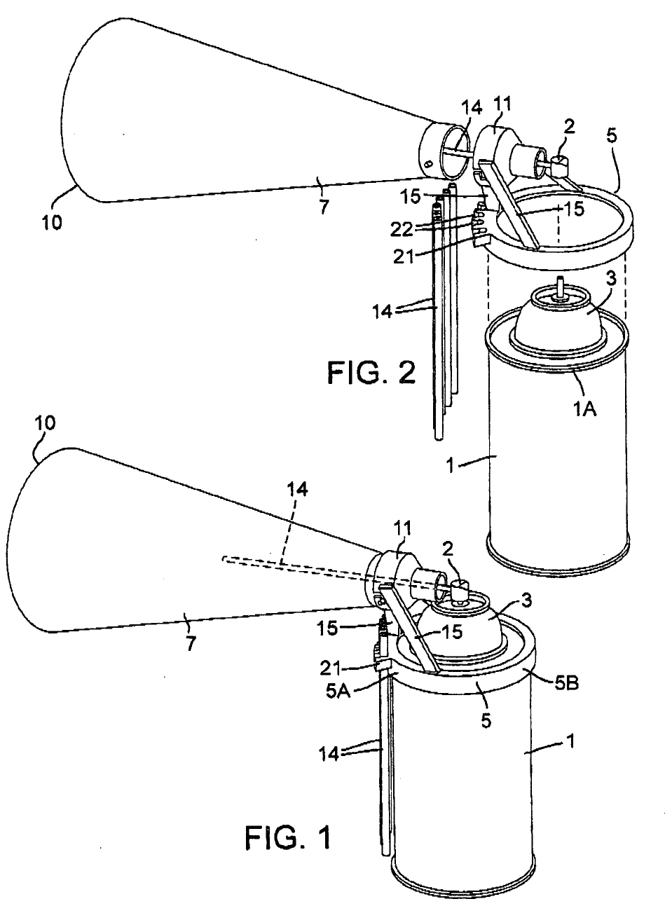

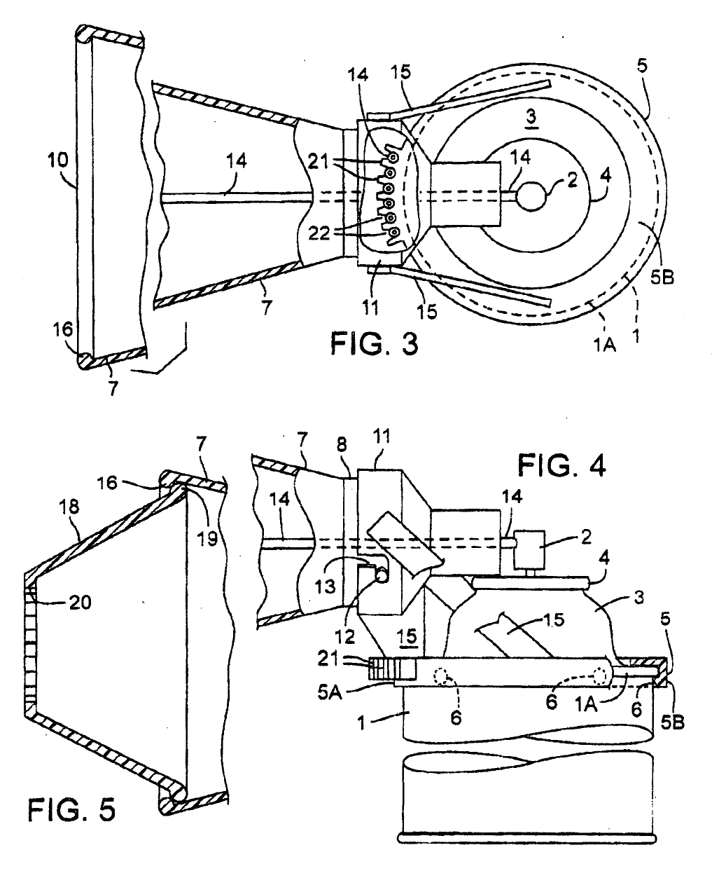

### DETAILED DESCRIPTION OF THE PREFERRED EMBODIMENTS

With continuing attention to the drawings wherein applied reference numerals indicate parts similarly hereinafter identified, the reference numeral 1 indicates an aerosol container with contents under pressure for discharge via a combination, finger actuated valve and nozzle 2. A domed end of the container is at 3 having a cap 4. A container rim is at 1A.

With attention now to the present attachment, a base 5 seats about container rim 1A with the base confined by rim engaging bumps 6 seating below the rim.

A spray shield 7 has an inlet end 8 and a discharge end 10 with the former being shaped for engagement with a shield holder 11. Holder supports are at 15. For retention of shield 7, a pin 12 thereon seats within a slot 13 in the holder to permit shield substitution if desired. Holder 11 is of open construction for the passage of a spray tube 14 and an airflow during spray discharge. The inlet end of holder 11 is of a size and shape and positioned to permit use of the attachment without a spray tube if desired. It will be noted that spray tube 14 terminates outwardly at its distal end at a point offset inwardly from the discharge end 10 of the shield, thereby inhibiting the size of the spray pattern. For example, when the aerosol spray is for providing a textured surface coating, the spray pattern is of a relatively large diameter, when compared with a paint spray pattern, resulting in added effort to the user to accomplish overspray removal. Any collection of spray occurring on the interior of shield 7 is confined against dripping from the shield end by a bead 16 which may additional serve to retain in place a later described spray confining attachment.

For use when very small areas are to be treated, the user may install in shield end 10 a spray restrictor 18 as shown in FIG. 5. The attachment defines a discharge opening 20, and is of somewhat flexible construction for engagement with bead 16 of the shield.

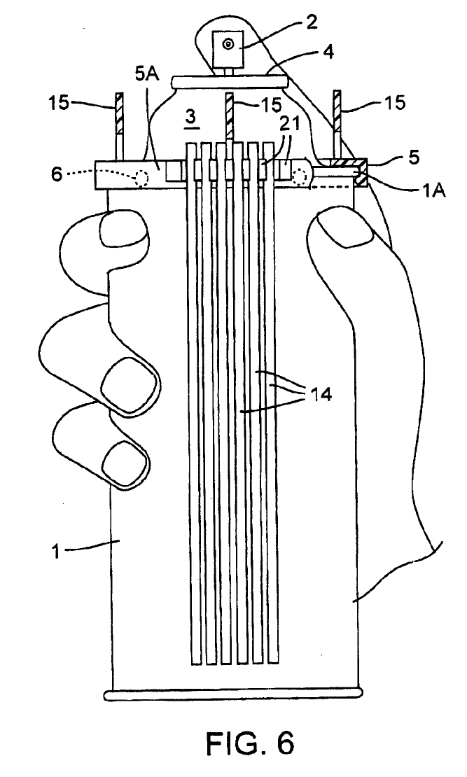

With certain makes of aerosol canisters spray tubes 14 of different internal diameters are provided. As shown in FIG. 6, the present attachment permits spray tube placement adjacent the frontal aerosol surface of a container avoids interference with grasping of the container by the user. Depending upon the user's objectives, one or more spray tubes may be carried by engagement of a spray tube with spaced apart projections 21 defining tube receiving open areas 22 on base 5.

In use of the present attachment base 5 is applied to the aerosol can rim with the raised areas or bumps 6 seating below the rim of the container. A spray tube is selected to best suit the task and spray medium at hand and is endwise inserted into the nozzle, which may be momentarily separated from a can discharge tube. Alternatively, the shield may be momentarily separated from its holder, the tube installed on the combination nozzle/actuator and the shield subsequently reinstalled.

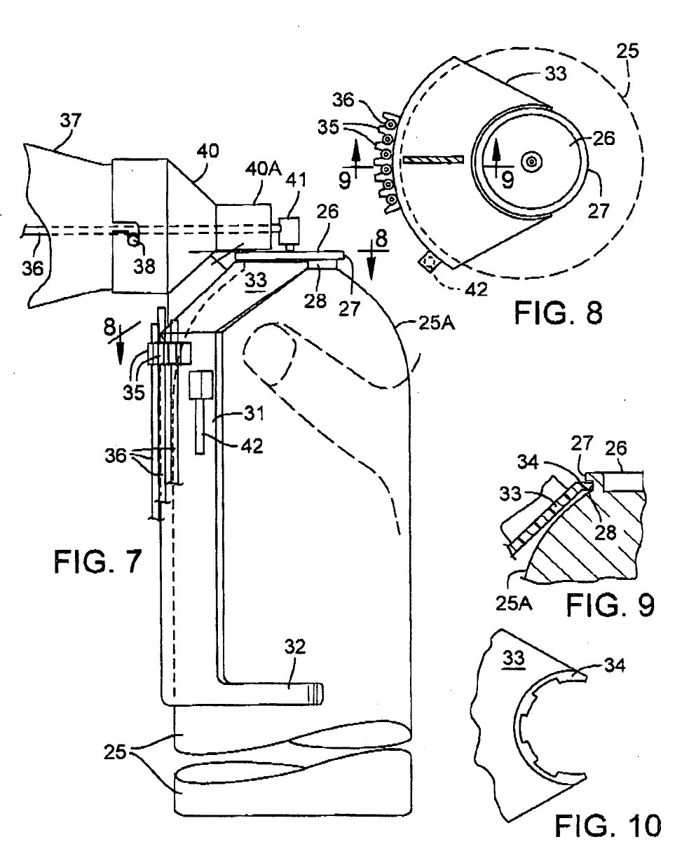

In FIG. 7 a preferred form of the attachment is shown on an aerosol canister 25 having a dome shaped upper end portion 25A terminating upwardly in a cap 26 which has a perimeter 27 offset upwardly and outwardly from the upper end portion 25A of the canister and partially defines an annular recess or groove 28.

A base 31 of the preferred form of the invention partially overlies the frontal portion of cylindrical canister 25 with attachment means including a pair of flexible clips as at 32 which grip a major arc of the canister perimeter. Base 31 terminates upwardly in a conical skirt 33 overlying the adjacent domed portion 25A of the canister. With attention to FIGS. 8-10 an arcuate insert or lip 34 on the skirt flexes outwardly to seat in annular recess 28 below cap 26 to attach the base upper end to the canister. Lip 34 may be castellated to enhance flexibility.

In place on base 31 are projections 35 which serve to carry an array of spray tubes as at 36 adjacent the frontal area of canister 25. Preferably the spray tubes are of different inside diameters and lengths to provide the user a selection to best accomplish the current spraying task.

A shield at 37 may be like the shield earlier described and provided with a pin 38 for detachable engagement with a shield holder 40. A holder sleeve 40A terminates at an inlet end proximate the combination valve and nozzle 41 of the type found on aerosol canisters.

A probe at 42 in the base permits the user to periodically clear a clogged spray tube before attachment to nozzle/valve 41.

Upon installation of the attachment on an aerosol canister, the shield is removed from the holder for insertion of a spray tube end (if used) into the nozzle/valve 41 whereupon the shield (or a substitute shield of different configuration) is inserted into the holder.

While I have shown but a few embodiments of the invention, it will be apparent to those skilled in the art that the invention may be embodied still otherwise without departing from the spirit and scope of the claimed invention.

Having thus described the invention, what is desired to be secured by a Letters Patent is:

I claim:

1- An attachment for confining spray from an aerosol container, said device comprising,
an elongate shield having an inlet end and a discharge end,
a base including attachment means for engagement with the aerosol container,
a holder for said elongate shield carried by said base, and
retainer means on the base for reception of one or more substitute spray discharge tubes.

2- The attachment claimed in claim 1 wherein said retainer means is disposed on the frontal portion of said
base.

3- The attachment claimed in claim 1 wherein said retainer means includes an array of projections each for frictional engagement with substitute spray discharge tube.

4- The attachment claimed in claim 3 wherein said projections define an open area for reception of a substitute spray discharge tube.

5- The attachment claimed in claim 1 wherein said elongate shield includes an end of cylindrical shape, said holder defining a socket for reception of the shield end, said holder and said end of the shield having inter-engageable locking members.

6- The attachment claimed in claim 1 wherein said attachment means includes expansible clips.

7- The attachment claimed in claim 1 wherein said attachment means includes an arcuate insert for engagement with a valve equipped end of the container.

8- The attachment claimed in claim 7 wherein said arcuate insert is of flexible construction.

9- An attachment for an aerosol spray canister having a cap and a nozzle for insertion of a spray tube and comprising,
a base,
means for detachably mounting one or more spray tubes to the base for subsequent installation in singular fashion on a canister nozzle, and
means coupling said base to an aerosol spray canister.

10- The attachment claimed in claim 9 wherein said means for detachably mounting one or more spray tubes to the base includes projections with which the spray tubes are individually engageable for retention.

11- The attachment claimed in claim 10 wherein said means coupling said base to an aerosol spray canister includes multiple projections for seating below a rim of the canister.

12- The attachment claimed in claim 9 wherein said means coupling said base to an aerosol spray canister includes paired flexible clips for biased engagement with the canister.

13- The attachment claimed in claim 12 wherein said means coupling said base to an aerosol spray canister includes a lip for inserted engagement with the canister subjacent a canister cap.
